(19) United States
(12) Patent Application Publication
(10) Pub. No.: US 2007/0053948 A1
(43) Pub. Date: Mar. 8, 2007

(54) Lens care solution demonstration kit

(75) Inventors: Daniel M. Ammon JR., Penfield, NY (US); Suzanne F. Groemminger, Rochester, NY (US); Dharmendra Jani, Fairport, NY (US)

Correspondence Address: Bausch & Lomb Incorporated, One Bausch & Lomb Place, Rochester, NY, 14604-2701, US

(73) Assignee: Bausch & Lomb Incorporated

(21) Appl. No.: 11/518,023

(22) Filed: Nov. 10, 2006

Related U.S. Application Data
(60) Provisional application No. 60/714,974, filed on Sep. 8, 2005.

(51) Int. Cl. A01N 25/00

(52) U.S. Cl. 424/405

(57) ABSTRACT

A demonstration kit and method for marketing lens care solution. The kit contains two demonstrations. One demonstration is directed to lubricity and the other demonstration is directed to protein stabilization. The protein assay uses a solution of urea.

### CROSS REFERENCE

This application claims the benefit of U.S. Provisional Application No. 60/714,974, filed Sep. 8, 2005.

### FIELD

This invention relates to a method of marketing lens care solution. The invention further relates to a lens care demonstration kit and method for comparing competitive lens care solutions.

### BACKGROUND

Contact lenses in wide use today fall into three general categories: hard lenses, formed from materials prepared by polymerization of acrylic esters, such as poly(methyl methacrylate) (PMMA); rigid gas permeable (RGP) lenses formed from silicone (meth)acrylates and fluorosilicone methacrylates; and gel, hydrogel or like soft-type lenses. The hard and rigid-type lenses, because they are characterized by low vapor diffusion and absorb only minor amounts of aqueous fluids, have a lower tendency to bind ingredients used in contact lens care solutions. On the other hand, soft-type lenses have a greater tendency to the bind active ingredients used in contact lens care solutions.

Therefore, developing solutions designed for the treatment of soft-type lenses, whether made from the more traditional copolymers of 2-hydroxyethyl methacrylate (HEMA) or from the newer silicon-containing hydrogel materials, is especially challenging. During the normal course of wearing contact lenses, tear film and debris consisting of proteinaceous, oily, sebaceous, and related organic matter have a tendency to deposit and build-up on lens surfaces. Many factors influence deposit formation, including patient to patient variation, lens material, care regimen, and environmental factors. In general, relatively high water content ionic lens materials absorb more protein than relatively low water content or nonionic lens materials. As part of the routine care regimen, contact lenses must be cleaned to remove tear film deposits and debris. If deposits are not properly removed, both the wettability and optical clarity of the lenses are substantially reduced and wearer discomfort may result.

Further, contact lenses must also be disinfected to kill harmful microorganisms that may be present or grow on the lenses. Some of the most popular products for disinfecting lenses are multi-purpose solutions that can be used to clean, disinfect and wet contact lenses, a subset of these solutions further capable of being directly inserted or placed on the eye without rinsing. Certainly, the ability to use a single solution for contact lens care is an advantage. Such a solution, however, must be particularly gentle to the eye, since at least a portion of the solution will remain on the lens when inserted or placed on the eye and will thereby come into direct contact with ocular tissues.

Many lens care solutions are available on the market. Multipurpose solutions have been described in the literature, for example, U.S. Pat. No. 4,820,352, issued to Riedhammer et al., and U.S. Pat. No. 5,096,607, issued to Mowrey-McKee et al., each disclose such solutions. More generally, contact lens solutions are disclosed in U.S. Pat. No. 5,356,555 to Huth et al., U.S. Pat. No. 5,401,431 to Nakagawa et al., U.S. Pat. No. 5,409,546 to Nakagawa et al., U.S. Pat. No. 5,449,442 to Yamada et al., U.S. Pat. No. 5,487,788 to Kamiya et al., U.S. Pat. No. 5,505,953 to Chowhan, U.S. Pat. No. 5,556,480 to Rontome et al., U.S. Pat. No. 5,607,908 to Potini et al., U.S. Pat. No. 5,630,884 to Huth, U.S. Pat. No. 5,648,074 to Park et al., U.S. Pat. No. 5,654,262 to Desai et al., U.S. Pat. No. 5,800,807 to Huth et al., U.S. Pat. No. 5,820,696 to Kimura et al., U.S. Pat. No. 5,858,937 to Richard et al., U.S. Pat. No. 5,922,279 to Spooner, U.S. Pat. No. 6,024,954 to Park et al. and U.S. Pat. No. 6,121,327 to Tsuzuki et al.

New compositions, including multipurpose lens care solutions, offer several key attributes relative to other competitive lens care solutions on the market. Sustained comfort, protein management including protein cleaning and stabilization, high disinfection efficacy, prevention of bacterial attachment, and lubrication are all desired.

It is important for the eye care professional to develop an understanding of the differences in competitive lens care solutions in order to offer the best lens care solution to the consumer.

It would be desirable to provide a method and demonstration kit to demonstrate lens lubricity.

It would also be desirable to provide a method and demonstration kit to demonstrate protein stabilization.

### SUMMARY

In one aspect, the present invention relates to the marketing and selling of lens care solutions, particularly multipurpose solutions, to the eye care professional. Provided is a demonstration kit that is both simple and portable. The demonstration kit includes samples of competitive lens care solutions and means for testing lubricity and protein stabilization. The demonstration kit provided herein may be used by a salesperson at tradeshows, sales meetings, and in doctors' offices to enable the eye care professional to understand the application and advantages of one lens care solution over competitive lens care solutions.

In another aspect, provided is a method of marketing lens care solution that includes the steps of: selecting two or more different lens care solutions, providing two or more ophthalmic lenses or polymeric substrates formed in the shape of a contact lens and combining the two or more different lens care solutions and two or more ophthalmic lenses to form a lens care solution demonstration kit.

In yet another aspect, provided is a method of marketing lens care solution comprising the steps of: selecting two or more different lens care solutions, combining each of the two or more different lens care solutions with a protein and a chemical denaturant to form two or more different combined solutions and forming a lens care solution demonstration kit that includes the two or more different combined solutions.

In still yet another aspect, provided is a method to determine the ability of a test solution to retard protein denaturing comprising the steps of: combining the test solution with a protein to form a combined solution, contacting the combined solution with a chemical denaturant drop wise, and visually inspecting the combined solution after each drop is added for formation of a white precipitate to determine the number of drops to denature the protein.

In a further aspect, provided is a demonstration kit for marketing lens care solutions, the kit including: a plurality of samples of lens care solution, at least two samples comprising a combination of protein and lens care solution, at least one sample of chemical denaturant, a plurality of closable vials, a plurality of ophthalmic lenses or polymeric substrates formed in the shape of a contact lens, each ophthalmic lens or polymeric substrate contained within a disk-shaped receptacle, and a carrying case.

In a still further aspect, provided is a demonstration kit for marketing lens care solutions that includes: a carrying case having pivotally connected interior portions, a pair of foam sections received within the interior portions, wherein at least a portion of one of the pair of foam sections is provided with a plurality of protuberances and at least a portion of the other of the pair of foam sections is provided with a plurality of recesses, the recesses including a plurality of bottle shaped recesses, a plurality of circular shaped recesses and a plurality of rectangular shaped recesses positioned about the carrying case, a plurality of threadably closable rigid vials arranged within one of the rectangular recesses, a plurality of squeezable containers arranged within the other of the rectangular recesses; a plurality of squeezable bottles for placement within the plurality of bottle shaped recesses, and a plurality of threadably closable disk-shaped receptacles.

### BRIEF DESCRIPTION OF THE DRAWINGS

FIG. 1 shows a plan view of the exterior of the carrying case for the demonstration kit of the present invention.

FIG. 2 shows a plan view of the carrying case in the open position for the demonstration kit of the present invention.

FIG. 3 shows an enlarged plan view of the recesses and elements in the demonstration kit of the present invention.

### DETAILED DESCRIPTION

During wear, contact lenses are susceptible to the accumulation of proteinaceous materials that may adhere to the surface of the lens. Such proteinaceous materials include, for example, lysozyme, lactoferrin, albumin, and mucoproteins, all constituents of lachrimal tears. Contact lenses that are repeatedly worn over an extended period of time must be cleaned to remove these materials as part of a routine care regimen.

In particular, if contact lenses are not properly cleaned, lysozyme, mucoproteins and the like can accumulate on the lenses and may lead to the lens wearer experiencing discomfort or a loss of visual acuity. The presence of proteinaceous deposits on the lens may also decrease gas permeability of the lenses or adversely affect the spectral characteristics of the lenses. Finally, proteinaceous deposits may interfere with the efficient sterilization of contact lenses.

A multipurpose lens care solution that provides sustained comfort, protein management, including protein stabilization, as well as lubrication, high disinfection efficacy and the prevention of bacterial attachment is desired by both eye care professionals and consumers. However, the wide variety of lens care solutions available commercially today makes it difficult for lens care professionals to recommend the appropriate solution best suited to their clients' needs without extensive consumer experience and feedback. In view thereof, it would be desirable to provide a demonstration and sales tool for comparing the lubricity and protein stabilization characteristics of various lens care solutions.

Disclosed herein is a method and demonstration kit capable of effectively comparing the protein stabilization of various lens care solutions. As may be appreciated, effective protein management is important to consumers and a key property of lens care solutions. Preventing proteins from denaturing and keeping them in their native state enables the proteins to function in their normal biochemical role and serves as an aid in reducing lens spoilage. This increases lens comfort for wearers.

Proteins exist in a three-dimensional configuration. This three-dimensional configuration allows proteins to carry out their biochemical activities. When a protein denatures, it loses its three-dimensional configuration and can no longer perform the necessary biochemical activities. Denatured protein is sometimes seen as a foreign body that may result in an immune response in a contact lens wearer. Denatured protein may also cause a contact lens to become cloudy and uncomfortable.

To demonstrate the protein management potential of a lens care solution, in particular the prevention of protein denaturation or precipitation, a protein, such as a lysozyme protein, is dissolved in a plurality of lens care solutions. For example, three different lens care solutions can be utilized, the lens care solution to be marketed and two other lens care solutions.

The lysozyme protein is a major component of the tear film and is involved in many functions in the eye. Perhaps, most importantly, the lysozyme protein protects the eye from infection caused by microbiological attack. Other suitable proteins for the demonstration kit of the present invention may include, but are not limited to, lactoferrin, albumin, and mucoproteins, all constituents of lachrimal tears.

The lysozyme protein is added to each lens care solution to form a solution having about 0.5% by weight lysozyme. About 10 drops (0.5 ml) of the combined solutions are added to three separate closable glass vials. A chemical denaturant, such as urea, is then brought into contact, drop wise, with each of the solutions being compared. The urea denaturant may be provided as a 5.0%, by weight, aqueous solution. Other suitable chemical denaturants for the demonstration kit of the present invention include, but are not limited to, trichloroacetic acid and the like. The chemical denaturant may also include sodium lauryl sulfate, to reduce the time required for the denatuation process. This is particularly advantageous when one considers that a person conducting a demonstration may have no more than ten minutes with the customer or doctor.

As may be appreciated, the greater the number of drops of chemical denaturant that can be added to the solution before the lysozyme protein becomes denatured, the greater the protection against protein denaturation provided by the lens care solution. Some solutions can require as little as a single drop of the urea solution to denature the lysozyme protein, while other solutions may require from about 8 to about 12 drops to denature a lysozyme protein. This test may be repeated several times.

When a protein becomes denatured, it can act as an irritant in the eye. The protein denaturation assay provided herein does not employ elevated temperatures to denature the protein; rather, a chemical denaturant, such as urea, is used to denature the protein. The test is carried out in the absence of heat, i.e. without a heating step. The test is performed at room temperature (between about 18 and about 30° C.). As may be appreciated, among the advantages of the protein denaturation assay disclosed herein are the simplicity and portability of the assay.

Also provided herein is a method and demonstration kit capable of comparing the lubricity of contact lenses, for example, in side-by-side demonstrations. The demonstration kit provided herein includes a plurality of large “elephant” demonstration lenses for use in the side-by-side comparison of lubricity. An elephant lens is a relatively large polymeric substrate having the shape of a contact lens. For use in the demonstration kit disclosed herein, the elephant lens may have a diameter of about three inches and a thickness of about 0.05 to about 0.07 inches, although other dimensions may be utilized as those skilled in the art will readily understand. Advantageously, the elephant lenses are formed to have a convex profile to better simulate the appearance of a typical contact lens. The elephant lens may be made of any suitable lens material, with hydroxyethyl methacrylate (HEMA) being particularly preferred. As an alternative to the elephant lenses disclosed herein, conventional consumer ophthalmic lenses may be substituted for the elephant lenses. As may be appreciated by those skilled in the art, such conventional consumer ophthalmic lenses include hard lenses formed from materials prepared by polymerization of acrylic esters, such as poly(methyl methacrylate) (PMMA), rigid gas permeable (RGP) lenses formed from silicone (meth)acrylates and fluorosilicone methacrylates, and gel, hydrogel or like soft-type lenses.

In conducting the side-by-side comparisons contemplated herein, each elephant lens or ophthalmic lens is soaked in a different lens care solution, for example, in the lens care solution being marketed and in another commercial lens care solution. The lenses are soaked for a period of at least four hours and may be soaked overnight or as otherwise directed by the manufacturer's regimen. After soaking, each lens is removed and handled simultaneously and may be rubbed between the thumb and forefinger to determine which lens is more lubricious. The more lubricious the lens, the smoother and slipperier the lens feels. As may be appreciated by those skilled in the art, lubricity is a result of the lens care solution binding to the surface of the lens and attracting and retaining moisture, making the lens more comfortable.

The demonstration kit provided herein may be used in conjunction with lens care solutions for all contact lenses such as: (1) hard lenses formed from materials prepared by polymerization of acrylic esters, such as polymethyl methacrylate (PMMA), (2) rigid gas permeable (RGP) lenses formed from silicone acrylates and fluorosilicone methacrylates, and (3) gel, hydrogel or soft type lenses made of polymerized hydrophilic or hydrophobic monomers, such as 2-hydroxyethyl methacrylate (HEMA).

Suitable multipurpose lens care solutions include, but are not limited to, those described in U.S. Pat. Nos. 4,820,352; 5,604,189; 5,858,937; 6,702,983; and 6,805,836; U.S. application Ser. Nos. 10/462,165; 10/724,679; 10/666,771; and 10/799,522; and U.S. Publication Nos. 2005/0119221; 2005/0119141; 2004/0186028; 2004/0115270 and 2004/0063591.

Suitable comparative lens care solutions include, but are not limited to, those lens care solutions described in U.S. Pat. Nos. 5,037,647; 5,393,491; 5,422,073; 5,500,186; 5,573,726; 5,593,637; 5,631,005; 5,756,045; 5,817,277; 6,063,745; 6,143,799; 6,289,906; 6,319,464; 6,319,883; 6,365,636; 6,503,497; and 6,482,781.

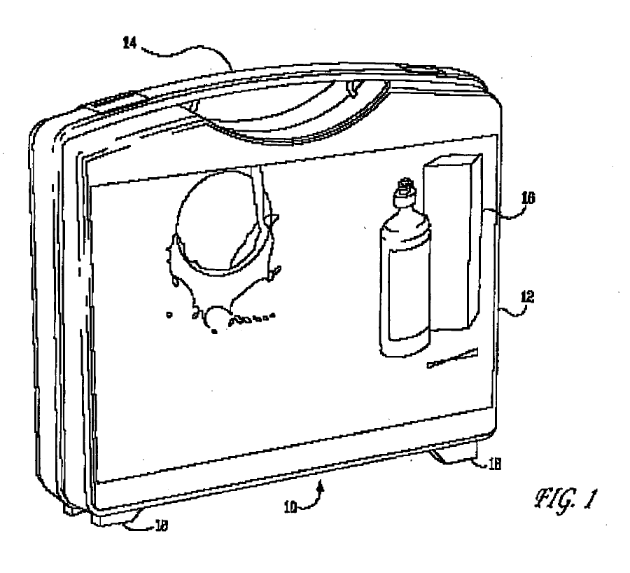

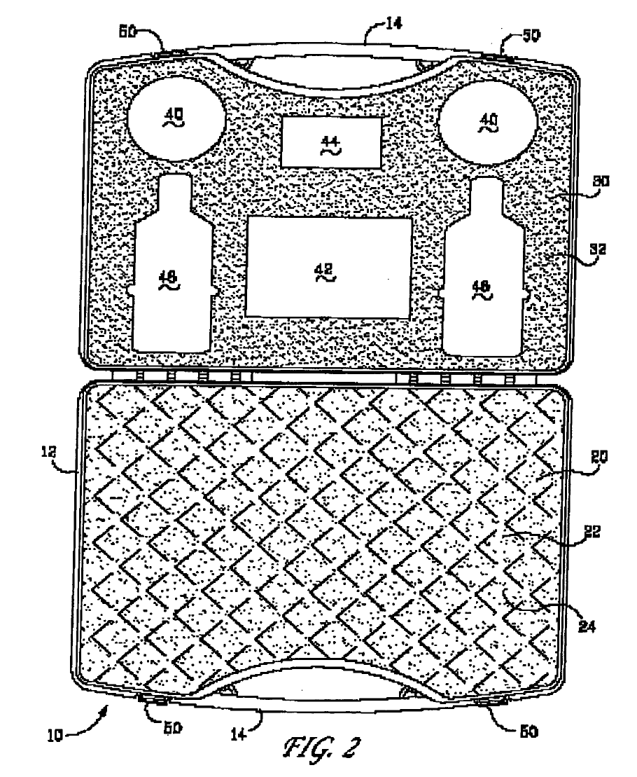

FIGS. 1 through 3 illustrate a portable demonstration kit for the purpose of testing and marketing lens care solutions. Advantageously, the kit effectively demonstrates the lubricity characteristics and protein stabilization of lens care solutions. Referring to FIG. 1, demonstration kit 10 includes carrying case 12. Carrying case 12 includes a rigid curved integral handle 14 and a surface for the optional placement of a product identifier placard 16. To enable carrying case 12 to stand unaided on a desktop or floor in a briefcase-like manner, carrying case 12 may also be provided with feet 18. As may be appreciated by those skilled in the art, carrying case 12 may be formed of a thermoplastic material, such as polypropylene, polyethylene or the like. As shown in FIG. 2, carrying case 12 may also be provided with latch members 50 for the secure closure of demonstration kit 10.

Referring now to FIG. 2, carrying case 12 of demonstration kit 10 may be opened to reveal two substantially equal interior portions, a first interior portion 20 and a second interior portion 30. The first interior portion 20 contains a foam section 22 having the dimensions of the interior of the first interior portion 20, foam section 22 being formed to have a plurality of protuberances 24. Foam section 22 is advantageously formed so as to have the appearance and function of material known in the packaging industry as “eggshell foam.” As may be appreciated, this material serves to protect the individual component parts of the demonstration kit 10. Optionally, an openable clear pocket (not shown) may be provided between foam 22 and the inner surface of carrying case 12 for storing a fibrous material for wiping, such as paper towel.

Second interior portion 30 contains a foam section 32 having dimensions approximating those of second interior portion 30 so as to enable a press-fit of foam section 32 therein. Foam section 32 is provided with a plurality of recesses, each recess being sized for positionally retaining a component part of the demonstration kit 10. The plurality of recesses includes a pair of substantially circular recesses 40, two substantially rectangular recesses 42 and 44 and a pair of bottle-shaped recesses 46. The pair of circular recesses 40 and the pair of bottle shaped recesses 46 may be positioned symmetrically about the center line C--C of the carrying case 12, as shown. Rectangular recess 42 and rectangular recess 44 may each be positioned to be aligned symmetrically on the center line C--C of carrying case 12.

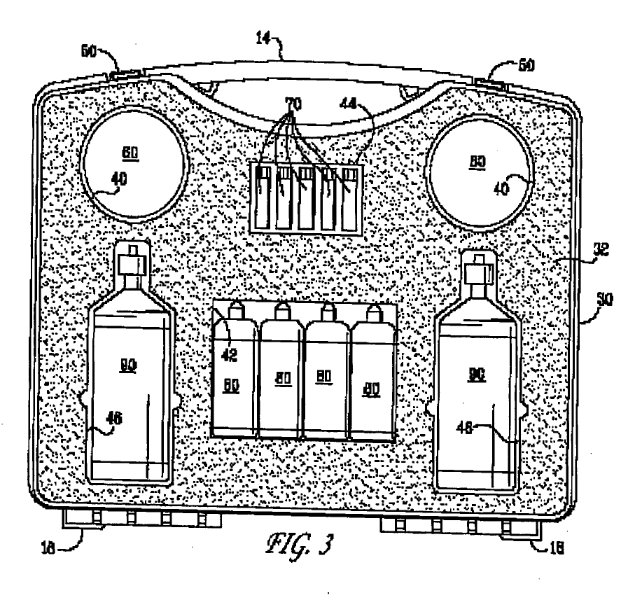

Referring to FIG. 3, an enlarged view of second interior portion 30 is shown fitted with the containers of demonstration kit 10. As shown, substantially circular recesses 40 each contain a large threadably closable, disk-shaped receptacle 60, each disk-shaped receptacle 60 sized to accommodate an elephant lens or conventional ophthalmic lens (not shown). Substantially rectangular recess 44 is sized to accommodate a plurality of rigid, elongated, threadably-closable vials 70. Vials 70 may be made of glass, plastics, or the like, with glass being particularly preferred. The demonstration kit may contain about fifteen vials 70 in order to run the protein management test (chemical denaturant assay) five times. Substantially rectangular recess 42 contains four squeezable containers 80, generally in the form of squeezable bottles. One squeezable container 80 may contain a solution of the chemical denaturant, urea. As is particularly preferred, the urea is present in the form of a 5% aqueous solution, with 1.5% sodium lauryl sulfate added thereto. The remaining three squeezable containers 80 may be provided with different multipurpose lens care solutions, each further containing a lysozyme protein present in an amount of about 0.5%, by weight. The recesses having a bottle shape 46 are each provided with a commercial size squeezable bottle 90 containing a commercial lens care solution. Instructions for the salesperson to use the kit to demonstrate the advantages of one multipurpose solution over competitive multipurpose lens care solution may be included in the kit.

The invention will now be more particularly described with reference to the following non-limiting examples.

### EXAMPLE 1

### Elephant Lens Demonstration of Lubricity

Two 2-hydroxyethyl methacrylate (HEMA) elephant demonstration lenses, having a diameter of about three inches and a thickness of about 0.06 inches, are conditioned with different contact lens care solutions. One lens is soaked in lens care Solution A, which is commercially available as ReNu® with MoistureLoc™ (available from Bausch & Lomb of Rochester, N.Y.). Solution A employs a combination of polyquaternium-10 (quaternized N,N-dimethylamino groups), poloxamer 407 (polyoxyethylene, polyoxypropylene block polymers), and Tetronic® 1107 (ethylene diamine adducts of polyoxyethylene, polyoxypropylene block polymers), available from BASF Corporation of Mt. Olive, N.J.). The other lens is soaked in lens care Solution B, which is commercially available as Opti-Free® Express® (available from Alcon Laboratories of Fort Worth, Tex.). The lenses are soaked for at least 4 hours.

The demonstration lenses are removed from the solutions and felt simultaneously by hand to determine which lens is more lubricious. The more lubricious lens will exhibit a smoother and more slippery feel. The lens soaked in lens care Solution A is clearly more lubricious than the lens soaked in lens care Solution B when evaluated by touch. The lens soaked in lens care Solution A feels more smooth and slippery than the lens soaked in lens care Solution B.

### EXAMPLE 2

### Protein Stabilization Demonstration

Lysozyme protein is dissolved in three different commercially-available multipurpose lens care solutions to form a combined solution having about 0.5%, by weight, lysozyme. Lens care Solution A is commercially available ReNu® with MoistureLoc™ (Bausch & Lomb of Rochester, N.Y.) and employs a combination of polyquaternium-10 (quaternized N,N-dimethylamino groups), poloxamer 407 (polyoxyethylene, polyoxypropylene block polymers), and Tetronic® 1107 (ethylene diamine adducts of polyoxyethylene, polyoxypropylene block polymers), available from BASF Corporation of Mt. Olive, N.J.). Lens care Solution B is commercially available Opti-Free® Express®, available from Alcon Laboratories of Fort Worth, Tex. Lens care Solution C is commercially available Complete® Comfort Plus™, available from Advanced Medical Optics, Inc. (AMO) of Santa Ana, Calif.

About 10 drops of each of the combined solutions are added to three separate 10 ml glass vials. A 5.0%, by weight, urea in water chemical denaturant solution, having 1.5% by weight sodium lauryl sulfate, is then added drop wise to each vial.

The protein assay is performed in the absence of adding heat (at room temperature). After just 1 drop, the lysozyme protein is denatured in the vials containing lens care Solutions B and C, as evidenced by the formation of a white precipitate. Ten drops are added to the vial containing lens care Solution A before the lysozyme protein is denatured and a white precipitate forms. As may be appreciated by those skilled in the art, lens care Solution A prevents protein denaturation better than lens care Solutions B and C.

All documents described herein are incorporated by reference herein, including any priority documents and/or testing procedures. As is apparent from the foregoing general description and the specific embodiments, while forms of the invention have been illustrated and described, various modifications can be made without departing from the spirit and scope of the invention. Accordingly, it is not intended that the invention be limited thereby.

What is claimed is:

1. A method of marketing lens care solutions, comprising the steps of:
(a) selecting two or more different lens care solutions;
(b) providing two or more ophthalmic lenses; and
(c) combining the two or more different lens care solutions and two or more ophthalmic lenses to form a lens care solution demonstration kit.

2. The method of claim 1, wherein the demonstration kit includes one ophthalmic lens for each lens care solution.

3. The method of claim 1, wherein each lens comprises 2-hydroxyethyl methacrylate.

4. The method of claim 1, wherein one of the two or more different lens care solutions comprises quaternized N,N-dimethylamino groups, polyoxyethylene, polyoxypropylene block polymers, and/or ethylene diamine adducts of polyoxyethylene, polyoxypropylene block polymers.

5. The method of claim 1, wherein the two or more ophthalmic lenses are selected from the group consisting of hard lenses formed from materials prepared by polymerization of acrylic esters, rigid gas permeable lenses formed from silicone (meth)acrylates and fluorosilicone methacrylates, gel and hydrogel soft contact lenses.

6. The method of claim 1, wherein the method further comprises the step of providing a squeezable container for each of the two or more different lens care solutions.

7. The method of claim 1, wherein the method further comprises the step of providing a threadably closable, disk-shaped receptacle for each lens.

8. The method of claim 7, wherein the method further comprises the step of soaking the two or more lenses in the two or more different lens care solutions, wherein each lens is soaked in the disk-shaped receptacle.

9. The method of claim 8, wherein each lens is soaked in the disk-shaped receptacle for a time period of at least four hours.

10. The method of claim 9, wherein the method further comprises the step of removing each soaked lens and manually feeling each lens simultaneously to determine which lens is more lubricious.

11. The method of claim 1, wherein the method further comprises the step of providing a set of instructions for using the demonstration kit.

12. A method of marketing lens care solution comprising the steps of:
(a) selecting two or more different lens care solutions;
(b) combining each of the two or more different lens care solutions with a protein and a chemical denaturant to form two or more different combined solutions; and
(c) forming a lens care solution demonstration kit that includes the two or more different combined solutions.

13. The method of claim 12, wherein the protein is selected from the group consisting of lysozyme, lactoferrin, albumin and mucoproteins.

14. The method of claim 13, wherein the protein is lysozyme.

15. The method of claim 13, wherein each combined solution comprises 0.5%, by weight, protein.

16. The method of claim 15, further comprising the step of providing a squeezable container for storing the two or more different combined solutions, each of the combined solutions contained in a separate squeezable container.

17. The method of claim 16, further comprising the steps of providing a closable vial for each combined solution and adding drop wise, ten drops of each combined solution to each vial.

18. The method of claim 12, wherein the chemical denaturant comprises urea.

19. The method of claim 18, wherein the chemical denaturant further comprises sodium lauryl sulfate.

20. The method of claim 17, further comprising the step of providing a squeezable container for storing the chemical denaturant.

21. The method of claim 20, further comprising the step of adding the chemical denaturant drop wise to each vial of combined solution until the protein precipitates in the combined solution.

22. The method of claim 21, wherein the chemical denaturant is added in the absence of heat.

23. The method of claim 21, wherein one of the lens care solutions comprises quaternized N, N-dimethylamino groups, polyoxyethylene, polyoxypropylene block polymers, and/or ethylene diamine adducts of polyoxyethylene, polyoxypropylene block polymers.

24. The method of claim 21, wherein the chemical denaturant is added in an amount in the range of between about 8 to about 12 drops.

25. The method of claim 24, wherein the chemical denaturant is added in an amount of about 10 drops.

26. The method of claim 12, wherein the method further comprises the step of providing a set of instructions for using the demonstration kit.

27. A method for determining the ability of a test solution to retard protein denaturing, comprising the steps of:
(a) combining the test solution with a protein to form a combined solution;
(b) contacting the combined solution with a chemical denaturant drop wise; and
(c) visually inspecting the combined solution after each drop is added for formation of a white precipitate to determine the number of drops to denature the protein.

28. The method of claim 27, wherein the test solution is a lens care solution.

29. The method of claim 27, wherein the protein comprises a lysozyme protein.

30. The method of claim 27, wherein the chemical denaturant comprises urea.

31. The method of claim 30, wherein the chemical denaturant further comprises sodium lauryl sulfate.

32. The method of claim 27, wherein said contacting is conducted in the absence of heat.

33. The method of claim 27, wherein the test solution comprises quaternized N,N-dimethylamino groups, polyoxyethylene, polyoxypropylene block polymers, and/or ethylene diamine adducts of polyoxyethylene, polyoxypropylene block polymers.

34. A demonstration kit for marketing lens care solution, the kit comprising:
(a) a plurality of lens care solutions;
(b) a plurality of samples comprising a combination of protein and lens care solution;
(c) at least one sample of chemical denaturant;
(d) a plurality of closable vials;
(e) a plurality of ophthalmic lenses or polymeric substrates formed in the shape of a contact lens, each ophthalmic lens or polymeric substrate contained within a disk-shaped receptacle; and
(f) a carrying case.

35. The kit of claim 34, further comprising a pair of foam pieces, wherein one of said pair of foam pieces contains cutouts.

36. The kit of claim 34, further comprising a set of instructions for using the demonstration kit.

37. A demonstration kit for marketing lens care solution, the kit comprising:
(a) a carrying case having pivotally connected interior portions;
(b) a pair of foam sections received within the interior portions, wherein at least a portion of one of said pair of foam sections is provided with a plurality of protuberances and at least a portion of the other of said pair of foam sections is provided with a plurality of recesses, said recesses including a plurality of bottle shaped recesses, a plurality of circular shaped recesses and a plurality of rectangular shaped recesses positioned about the carrying case;
(c) a plurality of threadably closable rigid vials arranged within one of the rectangular recesses;
(d) a plurality of squeezable containers arranged within the other of said rectangular recesses;
(e) a plurality of squeezable bottles for placement within the plurality of bottle shaped recesses; and
(f) a plurality of threadably closable disk-shaped receptacles.

38. The kit of claim 37, further comprising a set of instructions for using the demonstration kit.

39. The kit of claim 37, wherein each disk-shaped receptacle contains an ophthalmic lens or polymeric substrate formed in the shape of a contact lens.

40. The kit of claim 37, wherein each of said squeezable bottles contains a different lens care solution.

41. The kit of claim 37, wherein one of said plurality of squeezable containers contains a chemical denaturant.

42. The kit of claim 40, wherein each of the other of said plurality of squeezable containers contains a different lens care solution and a protein to form a combined solution, wherein said protein in each container is the same.

43. The kit of claim 42, wherein said protein is selected from the group consisting of lysozyme, lactoferrin, albumin and mucoproteins.

44. The kit of claim 43, wherein said protein is lysozyme.

45. The kit of claim 43, wherein each combined solution comprises 0.5%, by weight, protein.
